(19) United States
(12) Patent Application Publication
(10) Pub. No.: US 2009/0000940 A1
(43) Pub. Date: Jan. 1, 2009

(54) Method and Apparatus for Oil and/or Oil Product Treatment

(76) Inventors: Alexandr Vladimirovich Koss, Moscow (RU); Roman Andreevich Penzin, Moscow (RU)

Correspondence Address: BACHMAN & LAPOINTE, P.C., 900 CHAPEL STREET, SUITE 1201, NEW HAVEN, CT, 06510, US

(21) Appl. No.: 12/159,230

(22) PCT Filed: Mar. 30, 2006
(86) PCT No.: PCT/RU06/00151

§ 371 Date: Jul. 20, 2008

(30) Foreign Application Priority Data
Dec. 27, 2005 (RU) 2005140642

(51) Int. Cl. B01D 3/10

(52) U.S. Cl. 203/91; 202/205

(57) ABSTRACT

A method of oil and/or oil product treatment is carried out by producing a physico-mechanical effect on a moving flow of oil and/or oil products by changing pressure along the flow, wherein the pressure of at least 0.35 MPa being created at the flow inlet, which is subsequently reduced to a value not in excess of 0.05 MPa to provide the formation of the vapor-liquid mixture, followed by pressure increase at the flow outlet to at least 0.1 MPa. The unit for producing effect on the moving flow by pressure drops comprises an inlet piping with a multi-nozzle block hermetically fixed in its cross-section connected to a cylindrical channel and an expanding diffusor having a half-angle not in excess of 4 degrees. The ratio of the cylindrical channel cross-section area to the sum of nozzle hole area at the outlet from the multi-nozzle block ranges from 2.1 to 5.9.

### PERTINENT ART

The invention is referred to petrochemical industry, namely, to production of various fractions of hydrocarbons with maximum extraction of the tops (light fractions) in the course of primary treatment.

### PRIOR KNOWLEDGE

At this point all traditional methods of crude oil treatment generally include three stages:
the stage of oil preparation (desufurization, removal of hydrophilic impurities, water and salts);
the stage of direct primary distillation yielding the tops (light fractions) and fuel oil;
the stage of catalytic cracking of fuel oil yielding additional amount of the tops and paraffin.

Diverse methods of oil treatment aimed at partial change in the structure of hydrocarbon bonds for increasing the yield of light fractions at the very first stage of oil direct distillation are progressing of late.

There is a well-known method of treating oil and petroleum products by the applying ionizing γ radiation or fast neutron flow, the product yielded being subjected to catalytic cracking or hydrorefining or electrodesalination (RU 2100404, 27 Dec. 1997).

The method of petroleum products treatment by applying ionizing γ radiation or fast neutron flow has a drawback, which consists in the arising radiation hazard and great complexity of the unit and the relevant difficulty of its operation. Meanwhile, radiation effect gives rise to induced radiation in the petroleum product treated besides the unit structure materials.

A method is known consisting in oil treatment with low-frequency acoustic vibrations by means of vibration submerged jets and by hydraulic shocks at a frequency equal to intrinsic frequency of the vibration submerged jets and amplitude, which provides transfer of the fluid bulk into vibroboiling state. A device for the method implementation integrates a body, a vibroexciter, perforated partitions and nozzles, plungers with membranes and a gas separator (RU 2079328, 20, May, 1997).

Low efficiency from the viewpoint of the volume of the tops contained in the treated petroleum product can be mentioned among drawbacks of oil treatment with low-frequency acoustic vibrations.

A method is known, according to which, prior to feeding the stripped oil to an atmospheric column or fuel oil to a vacuum column, the flow undergoes complex hydromechanical and acoustic treatment in a rotor-pulse acoustic unit in the range of velocity gradients in the gap between the rotor and stator 4.7*10³-1.3*10⁷ s⁻¹ at the rotor rotational speed 1000-12500 rev/min, when acoustic field, its intensity 10²-10⁵ W/cm², is applied in the range of the rotor and stator disc-fan vibration frequencies 0.01-63.0 kHz. As a result of a change in the oil or fuel oil dispersed state, the yield of oil distillate fractions increases compared to traditional methods of oil distillate fractions production (RU 2158288, 27, Oct. 2000).

High energy and materials intensity along with insufficient increase in the amount of distillate fractions, which is no more than 13% wt., can be referred to shortcomings of the method of complex hydromechanical and acoustic treatment in a rotor-pulse acoustic unit described above.

There is a method, according to which the mechanochemical activation of hydrocarbons is attained by passing hydrocarbons through a disintegrator by applying shocks at a frequency from 3 to 12 per time period ranging from 0.001 to 0.01 s (U.S. Pat. No. 4,323,448, 06, Apr. 1982). The method permits increasing the yield of the tops in the course of subsequent rectification of the hydrocarbons by 1-2% at most compared with rectification of hydrocarbons without preliminary treatment.

There is a method, according to which liquid hydrocarbon compounds are placed in an artificial gravitational field and mechanical energy is applied to the liquid, being moved in reference to each other. The device integrates a process vessel for feeding the liquid, placed on rotating supports for creating an artificial gravitational field for the liquid in the process vessel. The process vessel is provided with mechanical means for applying mechanical energy to the liquid placed in artificial gravitational field. The invention permits evaporating and decomposing the compounds at a reduced evaporation temperature (RU 2122457, 27 Nov. 1998).

High materials and energy intensity are characteristic drawbacks of the method proposed.

A method is known, according to which, prior to vacuum distillation, the residual petroleum product is subjected to impact of magnetostatic field with magnetic flux density 0.1-0.4 T at the flow rate 0.001-0.05 m/s. Lines of the magnetostatic field intensity are directed in perpendicular to the liquid flow vector. The vapors formed are removed from the boiling area in parallel with the distillation film, being subsequently cooled and condensed (RU 2230094, 10 Jun. 2004).

Low efficiency of the method (2-7 vol. %) is its major drawback.

Units are known for facilitating the oil stock rectification processes without resorting to liquid-gas ejector for preliminary treatment.

For instance, there is an injector designed for use in evacuation units within rectification towers. A liquid working fluid with saturated vapor pressure no less than the one in the vacuum rectification tower is fed to the nozzle of a liquid-gas ejector. Pressure ranging from 1.1 to 160 pressures of gas-vapor phase in the rectification tower at the inlet to its ejector is maintained in the separator. After mixing the gas-vapor phase and liquid working fluid, prior to the mixture feeding to the separator, but after the mixture discharge from the gas-liquid ejector, the process of condensation in the liquid working fluid of readily condensed components of the gas-vapor mixture is arranged, giving rise to formation of a gas-liquid mixture (RU 2113634, 20, Jun. 1998).

A similar unit for evacuation is known. The unit is fitted out with a jet flow transformer, integrating an expansion chamber and a downstream profiled flow section, the expansion chamber of the transformer from the inlet side being connected to the liquid-gas ejector outlet, while the transformer profiled flow section on the side of flow discharge is connected to the separator. The gas-liquid mixture from the ejector is fed to the jet transformer. At first the gas-liquid flow is transformed there into supersonic one and then the flow is retarded by formation of a pressure jump, after that the gas-liquid flow is fed to the separator, where it is separated into compressed gas and liquid working fluid. As a result, the unit operation efficiency improves (RU 2124147, 27 Dec. 1998).

However, the known units can be used solely for liquid product distillation and its condensation, not being designed for changing the initial product composition, as they do not provide increase in the yield of oil tops.

There is a well-known unit for treating liquid hydrocarbon medium for gaseous impurities, which integrates a feeding piping with a nozzle, a cylindrical channel for providing supersonic flow of the liquid fluid mixture with the gases separated from it, while the nozzle is implemented as a multi-nozzle mouth-piece hermetically sealed on the piping and featuring the ratio of transverse cross section area and the sum of nozzle hole areas equal to (6÷12):1, a diffuser with an opening angle 4÷6°, being installed downstream of the cylindrical channel, which is followed by a separation chamber fitted out with a manifold for gaseous impurities removal. The unit contains a liquid fluid lateral pipeline with a hydraulic lock in the form of the pipe bend (RU 2248834, 27, Mar. 2005).

The unit permits treating oil for hydrogen sulfide, being not fit for increasing the content of oil top fractions.

A method of separating a mixture of hydrocarbons with different boiling points is known, which consists in imparting movement along curvilinear trajectories to mixture of hydrocarbons and heat carrier prior to their direct contact within the mixing volume. Finally, local areas with essential reduction in pressure (both absolute and partial) are formed within the mixing volume. Then the overall flow of hydrocarbons and heat carrier is fed for dispersion, after that the separation products are removed. The unit for implementing the method consists of a contact turbulent evaporator, a separator and heat exchangers (RU 2148609, 10, May 2000).

The necessity to feed a high-temperature heat carrier (steam at a temperature of 600° C.) to the unit under a pressure up to 1 MPa can be mentioned among the method disadvantages decreasing the process economic indices.

The present invention is aimed at devising a method of oil and/or petroleum products treatment and the method implementation unit, which will permit increasing the yield of petroleum product tops without high energy consumption and complicated process equipment.

The task set is coped with by treating oil and/or petroleum products by physico-mechanical effect on a moving flow of oil and/or petroleum products. Based on this invention, the effect is produced by changing pressure along the flow, when a pressure of no less than 0.35 MPa is created at the flow inlet, being subsequently decreased to a value of no more than 0.05 MPa, which provides the formation of a gas-vapor-liquid mixture, the pressure at the flow outlet is then increased up to at least 0.1 MPa.

It proved preferable that the effect produced by pressure drops is repeated twice.

The method envisages that after pressure drop effect is applied to the petroleum products flow, it undergoes fractional distillation.

After the mentioned effect on the flow produced by pressure drop the gas-vapor and liquid phases can be separated. The produced liquid fraction can be subjected to chemical stabilization. The produced gas-vapor phase can be subjected to condensation.

When producing the pressure drop effect, it proved preferable that the temperature of initially fed source materials is below 18° C.

The unit for oil and/or petroleum products treatment integrates at least one pump and one device for producing effect of pressure drop on the moving flow, which integrates an inlet piping with a multi-nozzle block hermetically sealed in the cross section and connected with a cylindrical channel and eventually with an expanding diffuser with the one-half angle not in excess of 4 degrees, the ratio of the cylindrical channel cross section area to the sum of the nozzle hole areas at the outlet from the multi-nozzle block ranging from 2.1 to 5.9.

The unit can be additionally supplied with a separator installed downstream of the diffuser and fitted out with outlet liquid and gas-vapor phase piping systems.

The outlet piping systems of the unit separator are to be fitted out with regulated throttles.

The best modification of the unit integrates two devices for producing pressure drop effect on a moving flow, which are arranged in series.

It is preferable that a central body is installed at the outlet from the diffuser for its controlled movement inside the diffuser.

During implementation of the method, the selected modes of producing effect by pressure drops permit attaining the maximum yield of light fractions at a minimal cost.

It has been ascertained experimentally that effective modes of producing effect on oil and petroleum products from the viewpoint of attaining technical result are provided at pressure values in excess of 0.35 MPa with subsequent pressure reduction by a factor of at least 7, viz. 0.05 MPa at most. The values characterize the minimal pressure drop providing efficient operation of the unit. In principle, the pressure drop is restricted by engineering potentialities of the pumps used. The use of a pump that feeds oil at a pressure of 10 MPa will involve pressure set at a level of 0.01 MPa, viz. pressure will decrease by a factor of 1000.

A pressure in the cylindrical channel below 0.05 MPa will give rise to a critical drop between the pressure in the cylindrical channel and the diffuser outlet cross section, which is necessary for shock wave formation.

Conceptually, the lower is the pressure in the cylindrical channel, the greater is the impact of the shock wave on oil flowing out of the channel. However, further increase in the drop is not economically advisable, on the one hand, and the amount of low-boiling oil fractions passing to the vapor phase will increase at a lower pressure in the cylindrical channel, which may give rise to reduction of the shock wave impact, on the other hand.

It can be additionally pointed out that the factors included into dependable points of the formula are used in specific cases of the proposed process implementation.

Double production of pressure drop effect on the flow increases the yield of light fractions. Thrice repeated process does not involve essential increase in the yield, being unjustified economically.

The recommendation about feeding for treatment the source material at a temperature below 18° C. is explained by the following. With temperature decrease less amount of low-boiling fractions will pass from liquid state to vapor with the pressure reduction occurring in the cylindrical channel, which involves increase in the shock wave impact, i.e. improvement of results.

Separation of the gas-vapor and liquid phases within the separator provides separation of low-boiling fraction vapors evaporating in the cylindrical channel and gases evolving from oil/petroleum products, which can be fed for further use or storage separately from the remaining oil. Therefore, the unit is additionally equipped with a separator with gas-removing connecting pipe and liquid phase outlet piping. Controlled throttles are sometimes installed in the separator gas-outlet piping, which results in pressure increase inside the separator, producing additional effect on pressure buildup in the end of the process.

The isolated gas-vapor phase undergoes condensation, when it is necessary to condense the low-boiling fraction vapors evaporating within the cylindrical channel and gases evolving from the oil/petroleum products and feed them for further use or storage separately from the remaining oil.

The isolated liquid phase undergoes chemical stabilization in the case, when it is intended for storage.

A central body is installed at the outlet from the diffuser for its controlled movement inside the diffuser aimed at additional shock impact on the flow discharged from the diffuser, which results in increased yield of the light fractions.

### DESCRIPTION OF THE UNIT OPERATION

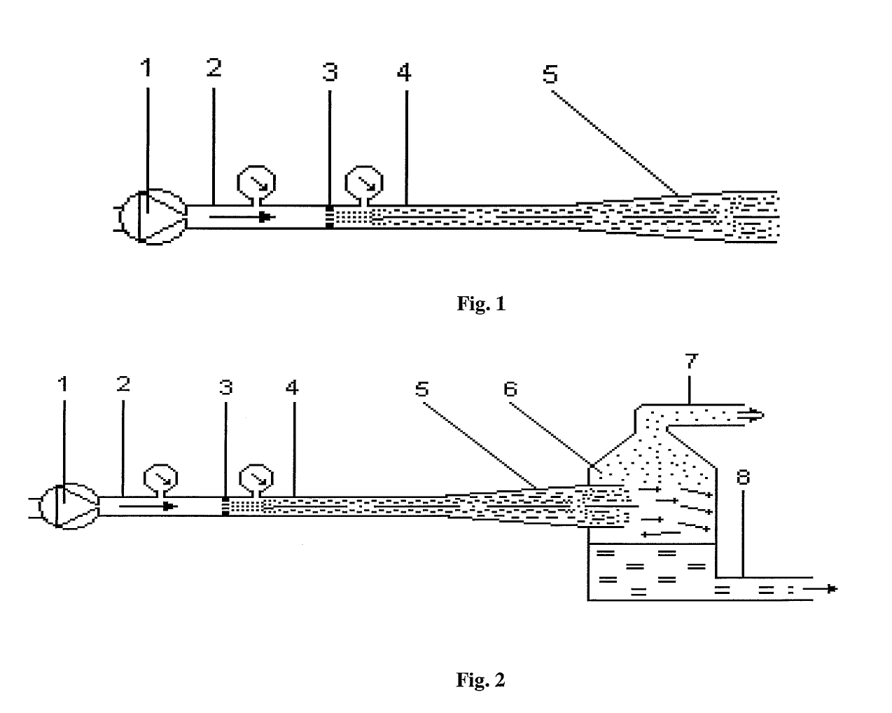

The unit depicted in FIG. 1 operates as follows. Oil is fed to pump—1 and its pressure is increased up to a pressure of Pᵢₙ but no less than 0.35 MPa. Then the oil along inlet piping—2 is fed to multi-nozzle block—3 which injects it to cylindrical channel 4. Within cylindrical channel ˜4 the absolute pressure P_{c.c.}≦0.05 MPa is realized as a result of the ejecting effect produced by the ejected oil (P_{c.c.} is dictated by the value of Pᵢₙ and the ratio of the cylindrical channel cross section area to the sum of the nozzle hole areas at the outlet from the multi-nozzle block, which makes up from 2.1 to 5.9). One should bear in mind the fact that oil/petroleum product gas factor, which is normally not in excess of 0.2, may affect the value of P_{c.c.} If the parameter is exceeded, oil/petroleum product supply at a temperature not in excess of 18° C. is provided. Hence, in cylindrical channel—4 a phase assuring at least a 7-fold pressure reduction is provided when passing from nozzle block—3 to cylindrical channel—4 (Pᵢₙ/P_{c.c.}≧7) the pressure making up no more than 0.05 MPa and a uniform flow is provided containing liquid phase along with gases and vapors evolved from low-boiling fractions. After that a final stage of abrupt pressure increase in the flow up to a value at the unit outlet P₀ₒᵤₜ no less than 0.1 MPa (atmospheric pressure) is conducted. It takes no more than 0.0004 s to realize the pressure increase mentioned mainly at the expense of the flow retarding in expanding diffuser—5, its half angle preferably 2-4 degrees. Then the process of oil/petroleum product treatment can be realized according to traditional flowsheet (feed for rectification, cracking, etc.).

The unit depicted in FIG. 2 operates similarly, but it permits separating gases evolved within cylindrical channel—4 and non-condensed vapors of low-boiling fractions evolved by oil/petroleum products in separator—6, fitted out with a gas-outlet pipe—7 for removing the light fraction gases and vapors, as well as outlet piping—8 for removing liquid oil/petroleum products. In this case, solely liquid oil/petroleum product is fed for further refining.

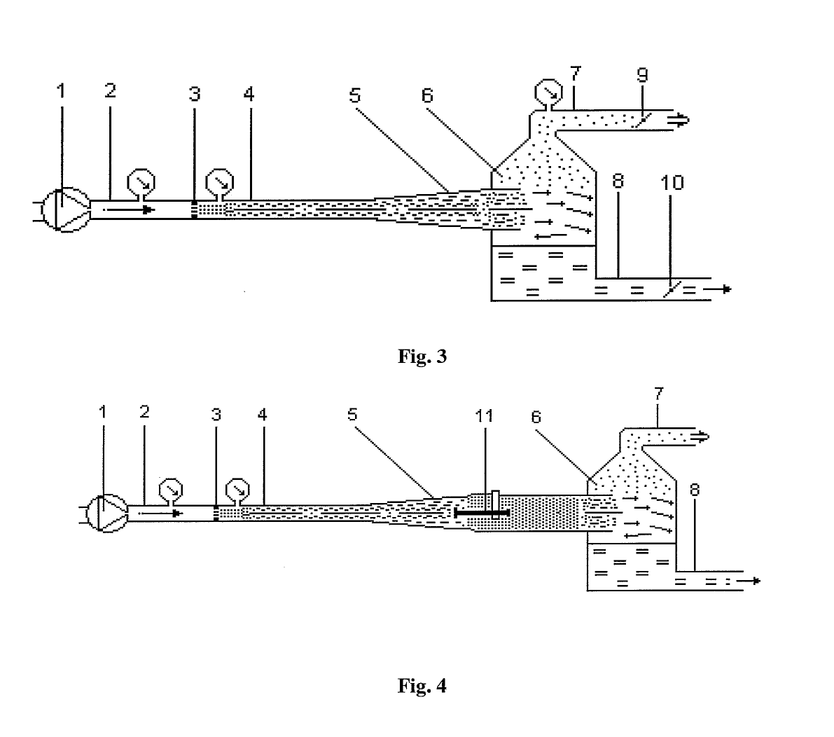

The unit depicted in FIG. 3 operates in a way similar to that of the unit in FIG. 2, though it permits creating excess pressure within separator—6 at the expense of controlled throttles—9 and—10. Thus, they regulate the degree of pressure buildup in diffuser—5, i.e. change the final stage of pressure increase in the flow up to the values exceeding 0.1 MPa.

The unit depicted in FIG. 4 differs from the one in FIG. 2 in potentiality of regulating the degree of pressure buildup in diffuser—5 (the final phase of pressure increase in the flow up to the values exceeding 0.1 MPa) due to central body—11 movement along the flow axis inside diffuser—5.

### EXAMPLE 1

The Almetyevsky field oil is treated in the unit shown in FIG. 1 at the following parameters:
Source material temperature: t=10° C.
Absolute pressure downstream of Pᵢₙ is set at 0.74 MPa.
A multi-nozzle block with the ratio of its cylindrical channel cross section area to the sum of the nozzle hole areas at the outlet from the multi-nozzle block α equal to 5.0 is used along with diffuser, its half-angle 4 degrees.

The following flow parameters are provided:
Oil flow rate in nozzles of the multi-nozzle block: W≈38 m/s.
Absolute pressure in the cylindrical channel: P_{c.c.}=0.02 MPa).
Pᵢₙ/P_{c.c.}pressure drop is 37.
The time of pressure buildup from the value of P_{c.c.} to the unit outlet pressure P₀ₒᵤₜ: =0.1 MPa (to atmospheric pressure) made up 0.00026 s.
Then 2 test samples (≈0.5 l) were taken from outlet piping—8 (FIG. 2), one of them being stabilized by hydroquinone (C₆H₄(OH)₂-1,4 dihydroxybenzene).

Repeated oil treatment is conducted at the same parameters. After the second treatment 2 samples were taken, one of them being stabilized with hydroquinone.

Samples of the initial oil and oil that underwent the treatment described above were subjected to fractional distillation under standard conditions.

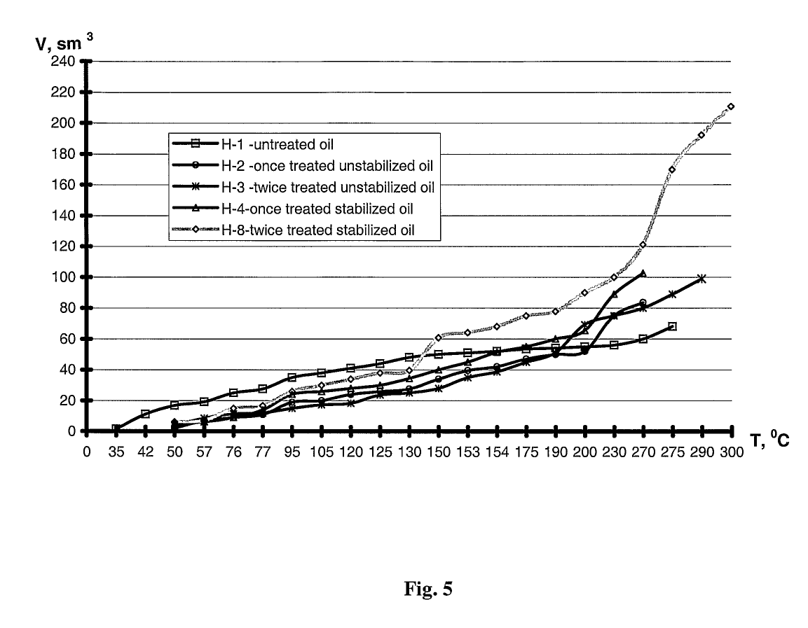

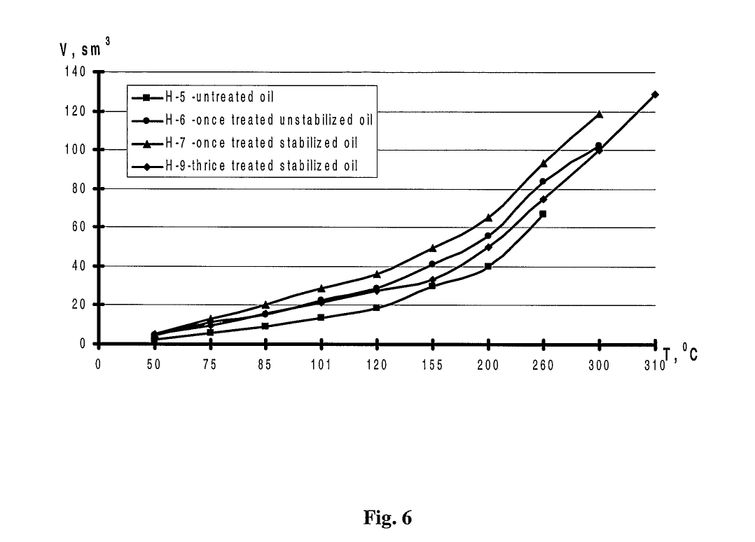

The results of the oil distillation are as follows: untreated oil (H-1), oil treated once using the method proposed (H-2), oil treated twice using the method proposed (H-3), treated once using the method proposed and stabilized with hydroquinone (H-4), treated twice using the method proposed and stabilized with hydroquinone (H-8) are provided as graphs in FIG. 5, where the volume of the fractions yielded is indicated along axis Y and the fraction temperature—along axis X.

It follows from analysis of the graphs that single treatment of oil without its stabilization with hydroquinone (sample H-2) permitted producing a 1.23 times greater volume of the light fractions than the volume yielded by distillation of the initial oil (sample H-1). Double treatment (sample H-3) increased the ratio of the volumes up to 1.44. Single treatment in combination with stabilization by hydroquinone (sample H-4) permitted attaining the ratio of the volumes equal to 1.51. The greatest effect was attained in the case of double treatment of the oil in the unit with subsequent stabilization with hydroquinone (sample H-8). A 3.1 times increase in the yield of the tops was achieved.

Stabilization with hydroquinone permits avoiding relaxation of the oil fractional composition during its storage.

### EXAMPLE 2

The process is conducted in the same way as in example 1, though heavy oil from the Buguruslanovsky field was treated at the same parameters. The results of fractional distillation of untreated oil (H-5), once treated oil (H-6), once treated and stabilized with hydroquinone oil (H-7), thrice treated and stabilized with hydroquinone oil (H-9) are provided as graphs in FIG. 6.

It becomes evident from analysis of the graphs that the single treatment of the oil without its stabilization with hydroquinone (sample H-6) permitted attaining a 1.53 times greater volume of the tops during fractional distillation, than the volume attained during distillation of the initial oil (sample H-5). Single treatment with stabilization by hydroquinone (sample H-7) permitted attaining a 1.77 times increase in volume. Thrice-repeated treatment in combination with stabilization by hydroquinone (sample H-9) permitted achieving increase in the volume of the tops by a factor of 1.92.

Analysis of the results shown in examples 1 and 2 suggests the conclusion that the most desirable effect from the viewpoint of increasing the yield of the tops was attained in the case of double treatment of the oil with its subsequent stabilization with hydroquinone (sample H8).

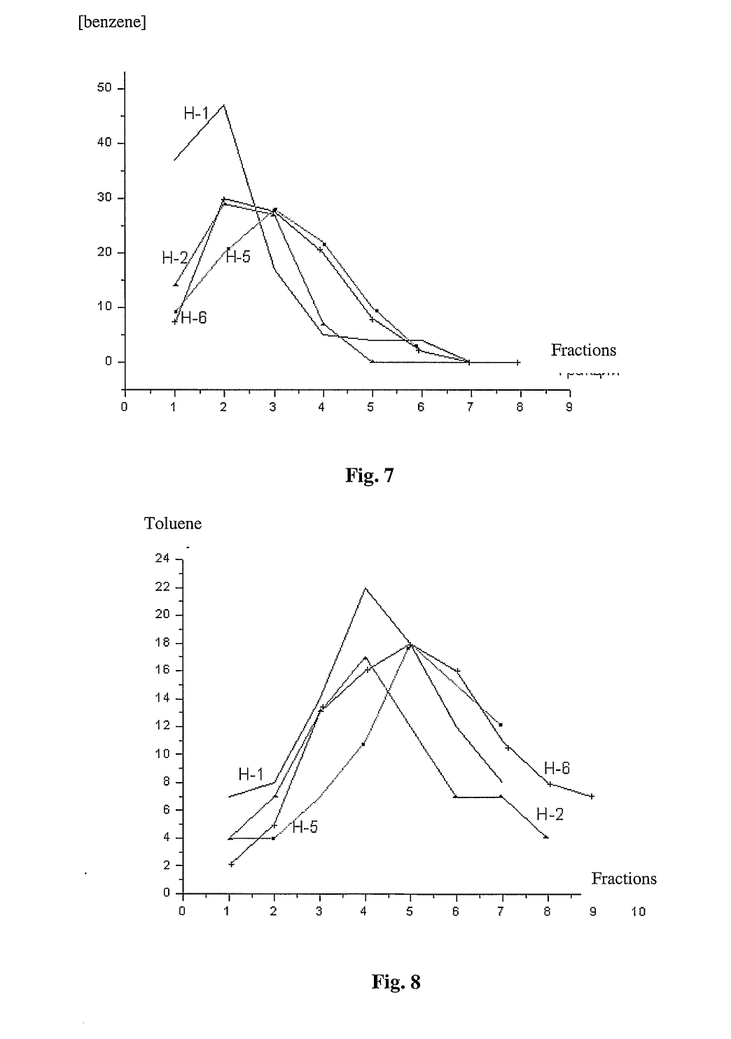

According to IR analysis data for samples H-1, H-2, H-5 and H-6 one can conclude that the oil treatment by pressure drops involved a change in its chemical composition (refer to FIGS. 7-11).

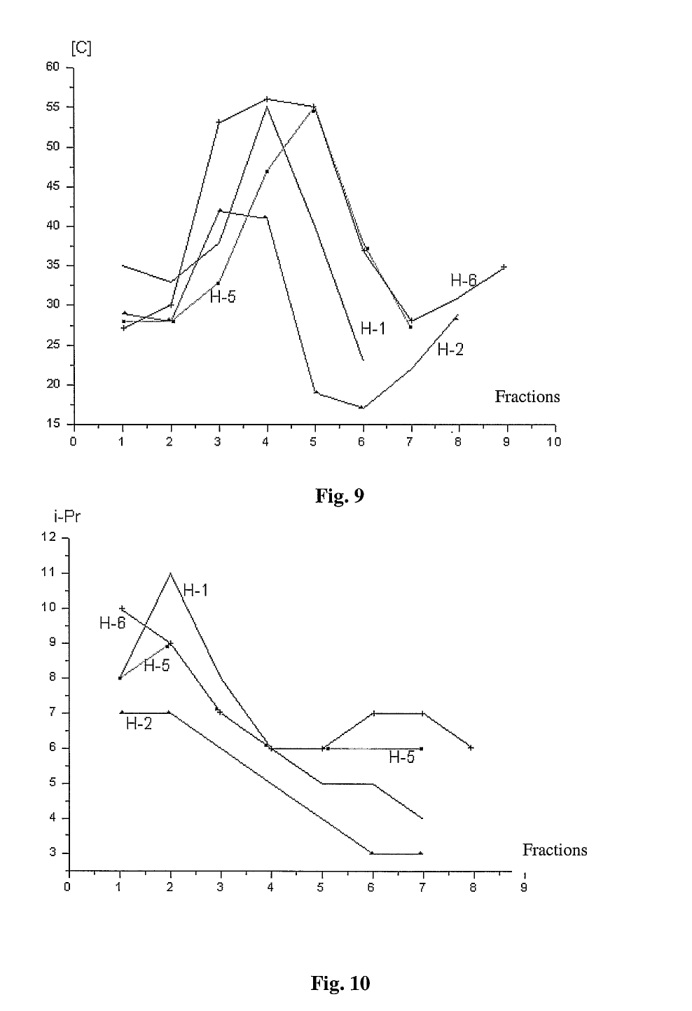

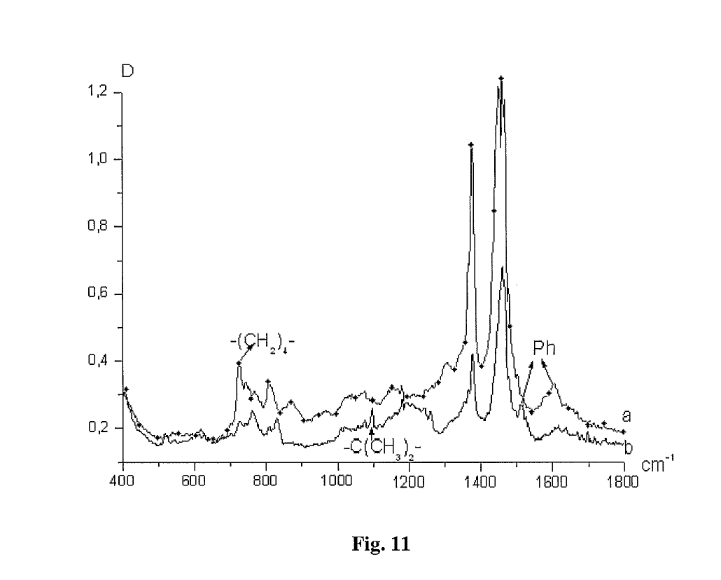

One can judge about the nature and relative content of hydrocarbons and functional groups in diverse fractions by the absolute intensities of the absorption bands assigned to different functional groups. The numerals along axis Y correspond to the absorption band intensities, which depends linearly on concentration of the given functional group in the sample according to the Bouguer-Lambert-Beer law

[C]=D/εd,

where D=absorption band intensity, ε=extinction factor (constant value for each absorption band), d=thickness of the recorded sample layer, [C]=concentration. As the spectra of all the samples were recorded in a cuvette of the same thickness, the concentration of the fraction component or overall concentration of the compounds containing the functional group mentioned is directly proportional to the band intensity (D). The graphs show changes [C] in diverse functional groups or mixture components in various (axis X) fractions of samples H-1, H-2, H-5 and H-6. FIG. 7 shows the change in benzene content in different fractions of oil samples H-1-H-6. FIG. 8 shows the change in toluene content in different fractions of oil samples H-1-H-6. FIG. 9 shows the content of saturated non-branched links —CH₂, that is ≧4. FIG. 10 shows the content if i-Pr groups in the hydrocarbons. FIG. 11
shows comparison of IR spectra for samples H-5 (a) and H-6 (b).

Comparison of IR spectra in individual fractions of samples H-1÷H-6 suggests the following conclusions:
1. Oil of sample H-1 contains by far greater amount of light products both paraffin and aromatic (benzene specifically). Very likely it contains the greatest amount of dissolved hydrocarbon gas. Oil in sample H-5 the content of the light products is lower, accordingly, the content of the light products in the oil undergoing the treatment is lower.
2. The oil treatment (H-2 and H-6) is responsible for the fact that similar in structure aromatic and saturated products fall into a wider range of fractions than in the initial oil.
3. After the treatment (H-2) the number of saturated normal hydrocarbons, which have no more than 5 CH₂ groups successively increases, while the number of the same hydrocarbons containing more than 5 CH₂ in succession decreases. The same tendency is traced for H-6 when compared to H-5.
4. Sample H-1 contains in all its fractions more branched hydrocarbons (i-Pr), than the treated sample H-2. After the treatment, an increase in the amount of both light products with isopropyl groups and heavy products with the same groups becomes evident for the pair H-5 and H-6.
5. In oil H-6 the nature of binding (association) of water in oil changes due to a change in water micelle dispersion.
6. Oil H-5 has 5-10% less degree of branching than oil sample H-1, which is suggested by relative intensity of the bands assigned to —CH₂- and —CH₃. Another situation is observed for oil H-6. Here the branching degree increases abruptly, being pronounced by relative increase in group CH₃ absorption band intensity. The number of linear chains —(CH₂)— exceeds 4. The number of tert-butyl and —CH₂-C(CH₃)₂-CH₂— type groups grows essentially greater (FIG. 11). The character and type of substitution in aromatic hydrocarbons change, as well.

Thus, the proposed treatment of oil (samples H-2 and H-6) produces the greatest effect on heavier petroleum products. Moreover, nonselective homolytic break of C—C bond (possible of C—H bond) occurs, giving rise to branching of the paraffin links and formation of new isopropyl-bearing light and heavy products containing fragments —C(CH₃)₂—.

### EXAMPLE 3

Diesel fuel was treated at parameters similar to the ones mentioned in example 1.

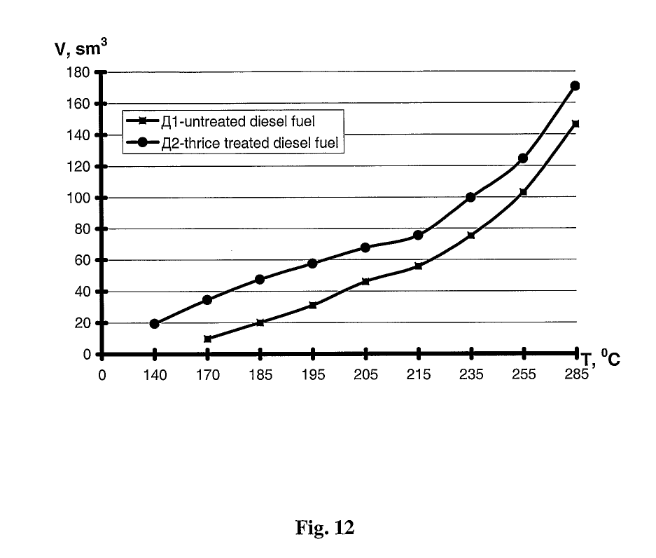

The results of distillation of untreated and triply treated diesel fuel are presented in FIG. 12. In the untreated diesel fuel a new fraction appears at 95-140° C. As in the case of oil treatment, the volume of light fractions after diesel fuel treatment increases from 146.3 ml to 170.4 ml.

### EXAMPLE 4

A very heavy oil from the Shishma Oil field (Tatarstan) was treated using the proposed method. Parameters are similar to the ones in example 1.

The results of fractional distillation of the untreated oil are provided in Table 1. The results of distillation of doubly treated oil stabilized with hydroquinone are provided in Table 2. It follows from analysis of the tables that density of the initial and treated oil has not actually changed (ρᵢₙᵢₜ=0.836, ρₜᵣₑₐₜ=0, 0.8385), meanwhile, total volume of treated oil fractions after distillation increased from 39.6 ml to 68.59 (by a factor of 1.73), the weight of the obtained fractions increased from c 30.2 g to 56 g (by a factor of 1.854), the density of the tops obtained increased from 0.763 kg/dm³ to 0.82 kg/dm³.

### EXAMPLE 5

The process was conducted in the same way as the one described in example 1, but in the unit, where the ratio of the cylindrical channel cross section area to the sum of the nozzle hole areas at the outlet from the multi-nozzle block made up (α)=5.9. Moreover, in the cylindrical channel the absolute pressure (P_{c.c})=0.018 MPa was established (Pᵢₙ/P_{c.c} pressure drop=41.1). The results of distillation of untreated and once treated oil practically coincided with results shown in FIG. 5 (Example 1, H-1 and H-2 dependences).

TABLE 1
Distillation of doubly treated oil. Stabilization with hydroquinone
Initial volume - 200 cm³. Total weight-167.7 g

| Still bottoms | Fraction | Fraction | Total | Fraction |
|---|---|---|---|---|
| temperature | temperature | volume | volume | weight |
| ° C. | ° C. | cm³ | cm³ | g |
| 41 | starting boiling point | | | |
| 180-195 | 41-50 | 0.9 | 0.9 | 0.5 |
| 196-205 | 51-80 | 5 | 5.9 | 3.8 |
| 206-244 | 81-95 | 4.2 | 10.1 | 3 |
| 245-257 | 96-130 | 9.2 | 19.3 | 6.85 |
| 258-275 | 131-155 | 5 | 24.3 | 4.2 |
| 276-311 | 156-200 | 10.29 | 34.59 | 9.15 |
| 312-380 | 201-295 | 34 | 68.59 | 28.5 |
| | | | | Σ = 56 |

TABLE 2
Distillation of untreated oil
Initial volume - 200 cm³. Total weight-167.2 g

| Still bottoms | Fraction | Fraction | Total | Fraction |
|---|---|---|---|---|
| temperature | temperature | volume | volume | weight |
| ° C. | °C. | cm³ | cm³ | g |
| 38 | starting boiling point | | | |
| 70-180 | 38-50 | 1.4 | 1.4 | 1.1 |
| 181-200 | 51-80 | 3.8 | 5.2 | 2.65 |
| 201-219 | 81-95 | 2.8 | 8 | 2.3 |
| 220-240 | 96-130 | 6 | 14 | 4.45 |
| 241-265 | 131-155 | 4.8 | 18.8 | 3.5 |
| 266-290 | 156-200 | 8.8 | 27.6 | 6.6 |
| 291-380 | 201-295 | 12 | 39.6 | 9.6 |
| | | | | Σ = 30.2 |

### EXAMPLE 6

### Comparative

The process was conducted as the one described in example 1, but:

Pressure created by the pump: Pᵢₙ=0.34 MPa.

Oil flow rate in the nozzles of the multi-nozzle block: W=25 m/s.

Absolute pressure in the cylindrical channel: P_{c.c.}=0.05 MPa.

Pressure drop Pᵢₙ/P_{c.c.}=6.8.

The results of the untreated and once treated oil distillation are provided in Table 3.

TABLE 3

| | Dynamic | | Yield of fractions (%) at the final boiling point, ° C. | | | | | | |
|---|---|---|---|---|---|---|---|---|---|
| | viscosity, | Density, | | up to | up to | up to | up to | up to | up to |
| Oil | mPa*s | kg/m³ | T_{boiling point} | 100 | 150 | 200 | 250 | 300 | 350 |
| Initial | 134 | 897 | 51 | 4 | 11 | 20 | 28 | 36 | 52 |
| Treated | 125 | 895 | 49 | 8 | 13 | 22 | 29 | 37 | 54 |

It follows from Table 3 that a 2° C. decrease in the boiling point of the light fractions occurred. Besides, the viscosity and density decreased when the yield of the light fractions increased by 4%.

This example demonstrates that overrun of the declared values of Pᵢₙ and Pᵢₙ/P_{c.c.}does not result in solution of the task set, as an increase in the yield of the light fractions (tops) is insignificant.

### EXAMPLE 7

### Comparative

The process was conducted as the one described in example 1, but:
The ratio of the cylindrical channel cross section area to the sum of the nozzle hole areas at the outlet from the multi-nozzle block: α=2.0.
Absolute pressure in the cylindrical channel: P_{c.c.}=0.045 MPa.
Pressure drop Pⁱⁿ/P_{c.c.}=16.4.

The results of the untreated and once treated oil distillation are provided in Table 4.

TABLE 4

| | Dynamic | | | | | | |
|---|---|---|---|---|---|---|---|
| | viscosity, | Density, | Yield of fractions (%) at the final boiling point, ° C., ml | | | | |
| Oil | mPa*s | kg/m³ | T_{boiling point} | up to 100 | up to 200 | up to 300 | up to 350 |
| Initial | 128 | 896 | 52 | 4 | 19 | 36 | 52 |
| Treated | 102 | 890 | 49 | 6 | 21 | 39 | 56 |

It becomes evident from Table 4 that a 3° C. decrease in the still bottoms boiling point occurred, the viscosity and density decreased with an increase in the yield of the light fractions by 8%.

It follows from the example that α=2.0 is inadequate for high efficiency of the process.

### EXAMPLE 8

Oil source: petroleum storage depot in Pskov.
Temperature: t=5° C.
Pressure created by the pump: Pᵢₙ=0.45 MPa.
The ratio of the cylindrical channel cross section area to the sum of the nozzle hole areas at the outlet from the multi-nozzle block: α=5.0.
Pressure at the outlet from the unit Pₒᵤₜ: =0.1 MPa.
Oil flow rate in the nozzles of the multi-nozzle block: W 29 m/s.

Absolute pressure in the cylindrical channel: P_{c.c.}=0.03 MPa.
Pressure drop: Pᵢₙ/P_{c.c.}=15.
   The results of the fraction distillation are shown in Table 5.

TABLE 5

| | Yield of fractions (%) at the final boiling point, ° C. | | | | | | |
|---|---|---|---|---|---|---|---|
| Oil | 66 | 90 | 110 | 120 | 140 | 180 | Note |
| Initial | 2.4 | 4.8 | 9.6 | 10.08 | 13.44 | 19.2 | Still bottoms |
| | | | | | | | starting boiling |
| | | | | | | | point 135° C. |

| | Yield of fractions (%) at the final boiling point, ° C. | | | | |
|---|---|---|---|---|---|
| Oil | 22 | 24 | 60 | 100 | Note |
| Treated | 0.95 | 1.9 | 13 | 27 | Still bottoms starting |
| | | | | | boiling point 97° C. |

By the results of the experiments a decrease in the still bottoms boiling point from 135° C. to 97° C. was detected along with more than twofold increase in percentage of the light fractions yield at temperatures below 100° C. (27/10.08=2.5).

Comparison of the results provided in examples 1 and 5 indicates that increase in geometric parameter (α) from 5 to 5.9 involves inessential pressure reduction in the cylindrical channel (from 0.02 MPa to 0.018 MPa) and the relevant increase in pressure drop from 37 to 41.1, which actually does not change the oil treatment efficiency. Decrease in geometric parameter (α) from 5 to 2.0 (see example 7) involves increase in pressure within the cylindrical channel from 0.02 MPa to 0.045 MPa and the relevant pressure drop from 37 to 16.4. It means that α=2 reduced the efficiency of the oil treatment. Example 7 suggests that a decrease in geometric parameter (α) is pointless, due to reduction of the treatment efficiency from the viewpoint of technical result achievement in terms of light fractions amount increase. Increase in geometric parameter (α) above 5.9 is inappropriate due to the flow separation from the cylindrical channel walls and, as a consequence, abrupt increase in pressure within the channel up to the atmospheric one. When the diffuser half-angle exceeds 4 degrees, there is no increase in the yield of the petroleum product tops due to separation of the gas-vapor-liquid flow formed in the cylindrical channel from the diffuser walls.

It becomes obvious from the examples above that the proposed technical approach permits effective treatment of oil for its subsequent fractional distillation, as it provides considerable increase in the volume (up to three-fold) of the oil light fractions during its rectification compared with untreated oil, as well as compared with oil treated according to the prior knowledge. The unit proposed is simple in manufacturing and efficient in operation.

1. A method of oil and/or oil product treatment by producing a physico-mechanical effect on a moving flow of oil and/or oil products, comprising the steps of producing a physico-mechanical effect by changing pressure along a flow of oil and/or oil products, wherein a pressure of at least 0.35 MPa is created at flow inlet and is subsequently reduced to a value not in excess of 0.05 MPa to provide the formation of the gas-vapor-liquid mixture followed by pressure increase at the flow outlet to at least 0.1 MPa.

2. The method of claim 1, wherein said pressure drop effect on the flow is produced twice.

3. The method of claim 1, wherein after the pressure drop effect on the flow the oil products undergo fractional distillation.

4. The method of claim 1, wherein after the mentioned pressure drop effect on the flow the gas-vapor and liquid phases are separated.

5. The method of claim 4, wherein that the obtained liquid phase undergoes chemical stabilization.

6. The method of claim 4, wherein the obtained gas-vapor phase is condensed.

7. The method of claim 1, wherein the raw material at a temperature below 18° C. is fed for treatment by pressure drop effect.

8. A unit for oil and/petroleum products treatment comprising at least one pump and at least one device for producing effect on a moving flow, the device for acting on the moving flow contains an inlet piping with a multi-nozzle block hermetically fixed in its cross section and connected to a cylindrical channel and to an expanding diffuser, its half-angle not in excess of 4 degrees, while the ratio of the cylindrical channel cross section area to the sum of the nozzle hole area at the outlet from the multi-nozzle block ranges from 2.1 to 5.9.

9. The unit of claim 8, wherein a separator is installed downstream of the diffuser, being fitted out with outlet piping systems for the liquid and gas-vapor phases.

10. The unit of claim 9, wherein the outlet piping systems of the separator are fitted out with the controlled throttles.

11. The unit of claim 8, wherein a central body is installed at the outlet from the diffuser for its controlled movement inside the diffuser.

12. The unit of claim 9, wherein a condenser is installed downstream of the separator.

13. The unit of claim 8, wherein two devices are installed in series, being used for producing the pressure drop effect on a moving flow.
